(19) United States
(12) Patent Application Publication
(10) Pub. No.: US 2024/0331066 A1
(43) Pub. Date: Oct. 3, 2024

(54) ARTIFICIAL INTELLIGENCE AUTO GENERATION OF FULL PROPERTY LISTING FOR REAL PROPERTY

(71) Applicant: REai, Inc., Atlanta, GA (US)

(72) Inventor: James Wang, Atlanta, GA (US)

(21) Appl. No.: 18/625,585

(22) Filed: Apr. 3, 2024

Related U.S. Application Data
(60) Provisional application No. 63/493,879, filed on Apr. 3, 2023.

(51) Int. Cl. G06Q 50/16; G06F 40/103; G06Q 30/0201; G06V 20/10

(52) U.S. Cl. CPC G06Q 50/16; G06F 40/103; G06Q 30/0206; G06V 20/176; G06Q 2220/00

(57) ABSTRACT

A method, apparatus, non-transitory computer readable medium, apparatus, and system for generating real property listings includes obtaining an image of a real property; performing, using an encoder of an image processing network, a convolution process on the image to obtain an image embedding representing features of the image; decoding, using a decoder of the image processing network, the image embedding to obtain property data for the real property; and generating, using a language generation model, a description of the real property based on the image and the property data. Embodiments are further configured to generate a listing of the property by mapping the extracted information from the property data to fields in a listing. Embodiments may then provide the listing on a public access layer of a distributed computer network or a private access layer of a distributed computer network.

### CROSS-REFERENCE TO RELATED APPLICATION

This U.S. non-provisional application claims priority under 35 U.S.C. § 119 to U.S. Provisional Patent Application No. 63/493,879, filed on Apr. 3, 2023, in the United States Patent and Trademark Office, the disclosure of which is incorporated by reference herein in its entirety.

### BACKGROUND

The following relates generally to data processing, and more specifically to generating real property listings. Real property listings include for-sale listings of real estate, vehicles, and other assets. Typically, a property listing is prepared by a real estate professional such as a real estate agent. Preparing the property listing entails aggregating the available data about the property, as well as obtaining any missing information. Further, the real estate professional must then describe the property, both to generate interest and to be compliant with local regulations. In some cases, the real-estate professional can miss or is otherwise unaware of some of the required fields for the listing. In such cases, the prepared listing includes a number of default or missing values leading to an ineffective or even non-compliant listing. There is a need for automated systems to generate accurate, compliant, and effective real property listings.

### SUMMARY

The present disclosure describes methods for generating property listings, as well as methods for providing the generated information on either a public access layer or a private access layer of a distributed computer network. Embodiments include a property listing apparatus with a property description generator. The property description generator is configured to encode one or more input image(s) and video(s) to generate image embeddings, decode the image embeddings to generate property data, and generate a property description based on the property data and the input media. The property description may be generated by a language model. Embodiments further include a listing component configured to incorporate the generated property description into a full property listing. The listing component may obtain a listing template, and identify fields in the template corresponding to the property data. Then, the listing component aggregates information from the generated property data, other available property data, and the generated property description to fill out the listing template, thereby generating a property listing. Additional features are provided by other components, the features including: property layout generation, property feature ranking, and buyer/seller recommendations.

A method, apparatus, non-transitory computer readable medium, and system for generating real property listings are described. One or more aspects of the method, apparatus, non-transitory computer readable medium, and system include obtaining an image of a real property; performing, using an encoder of an image processing network, a convolution process on the image to obtain an image embedding representing features of the image; decoding, using a decoder of the image processing network, the image embedding to obtain property data for the real property; and generating, using a language generation model, a description of the real property based on the image and the property data.

A method, apparatus, non-transitory computer readable medium, and system for generating real property listings are described. One or more aspects of the method, apparatus, non-transitory computer readable medium, and system include obtaining public information and private information for a real property; providing the public information via a public access layer of a distributed computer network in response to a public request for information about the real property; and providing the private information via a privileged access layer of the distributed computer network in response to a verified request for information about the real estate property.

### BRIEF DESCRIPTION OF THE DRAWINGS

FIG. 1 shows an example of a property listing system according to aspects of the present disclosure.

FIG. 2 shows an example of a property listing apparatus according to aspects of the present disclosure.

FIG. 3 shows an example of a property description generation pipeline according to aspects of the present disclosure.

FIG. 4 shows an example of a price prediction pipeline according to aspects of the present disclosure.

FIG. 5 shows an example of a listing generation pipeline according to aspects of the present disclosure.

FIG. 6 shows an example of a schematic generation pipeline according to aspects of the present disclosure.

FIG. 7 shows an example of a feature ranking pipeline according to aspects of the present disclosure.

FIG. 8 shows an example of a user recommendation pipeline according to aspects of the present disclosure.

FIG. 9 shows an example of a method for providing a listing to a user according to aspects of the present disclosure.

FIG. 10 shows an example of a method for generating a property description according to aspects of the present disclosure.

FIG. 11 shows an example of public and private layers according to aspects of the present disclosure.

FIG. 12 shows an example of a method for data processing according to aspects of the present disclosure.

FIG. 13 shows an example of a computing device according to aspects of the present disclosure.

### DETAILED DESCRIPTION

Currently in the real estate industry, new property listings are prepared manually by real estate professionals, or in rare cases manually prepared by homeowner. Preparing the listings manually is a long, tedious, and effort-consuming process. For example, the process can entail manually preparing a listing paragraph and manually filling in the required fields of features for the listing in compliance with industry regulations which can be hundreds or thousands of fields. Furthermore, the preparer almost always does not have capacity to include tags/captioning on each listing image/video, which is an ADA (American Disability Act) requirement for public facing media content.

Conventionally, when a property owner plans for a property sale, the owner contacts a real estate professional/agent who will come to the property to take pictures of the property, and manually fill the property listing (MLS listing or other related listing)-industry identified or required fields detailing property features and manually prepare listing description paragraphs. Then, the real estate professional submits the these sections including images, fields of features, and property description for property active listing in the local market. Current industry identified practices include gathering hundreds or even thousands of data items for each listing's features, which could come from a tax data source or other property data source, together with information obtained from listing agent's visit or from any available images and videos. The professional then fills the industry identified or required fields, and manually prepare a listing description with the above information. Typically, this effort takes 2 to 4 or more hours for a residential property. Despite, the large amount of time used, the listings are often not proper, accurate, or captivating.

For instance, the American Disability Act (ADA) mandates that all images and videos on display websites include tags for accessibility. However, due to time constraints and the rush to market, many listing agents often neglect to tag each image or video properly, leading to non-compliance issues. These pressures also mean that agents might not have the bandwidth to craft detailed, appealing listings that meet all requirements. It's not uncommon for agents to provide minimal descriptions, potentially leaving a negative impression on potential buyers. Furthermore, agents might overlook or default on specifying numerous mandatory features, breaking industry standards and further risking a poor reception. Additionally, many current listings fall short of various regulations due to missing tags or captions and may even breach specific MLS (Multiple Listing Service) rules concerning image and video quality, such as resolution and lighting. Consequently, these oversights can diminish the attractiveness of a listing to potential buyers or users, leading to missed sales opportunities, all while violating multiple rules and regulations.

Moreover, the realm of real estate is subject to constantly evolving rules and standards, such as those set by the Real Estate Standards Organization (RESO), Internet Data Exchange (IDX), and the American Disability Act (ADA), among others. These changes often lead to an increase in compliance requirements, making it even more challenging for listings to remain fully compliant. Neither listing agents, Multiple Listing Services (MLS) groups, nor other real estate listing platforms have the resources to ensure that a listing meets all regulatory standards before it goes live. For example, the RESO Data Dictionary alone encompasses thousands of standards that a listing agent is unlikely to fully address due to time and resource constraints, leading to non-compliance issues. This gap in compliance can be particularly disheartening for buyers or their agents who seek detailed or nuanced information about a property. Unfortunately, listing agents frequently lack the means to provide in-depth analyses or insights about properties, much less objective projections or recommendations. This deficiency can prevent buyers from obtaining a comprehensive understanding of a property's value and potential future worth.

Overall, the current process is not equipped to enable a smooth, automatic process for creating real estate listings properly. It is currently manual, tedious, and time consuming, and results in real estate listings that are prone to problems such as unappealing listing description, incorrect/missing information in the fields/features, information that violates various industry regulations, and missing image/video tags.

Embodiments of the present disclosure contrast from these conventional methods, and include methods for generating property descriptions from input images and videos. A property listing apparatus is configured to encode the inputs to create image embeddings, which are then decoded to produce property data. A property description is generated based on this data and the input media, using a generative machine learning model. Additionally, a listing component is included to incorporate the generated property description and other available property data into a property listing by utilizing a template and filling out its fields accordingly.

This automated approach addresses issues commonly associated with manual listing creation, such as incorrect or missing information, and non-compliance with industry regulations, by ensuring that all media is tagged with descriptions and all relevant data is accurately included in the listings. The system also introduces features such as property layout generation, ranking of property features, and recommendations for buyers and sellers, enhancing the utility and compliance of the property listings. This invention simplifies the process of creating real estate listings, making it more efficient and reducing the potential for errors or omissions.

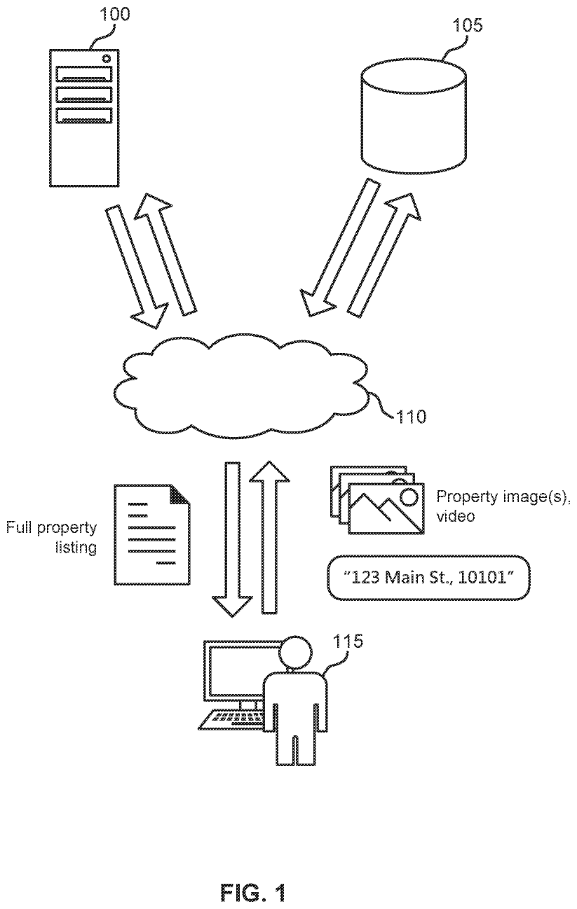

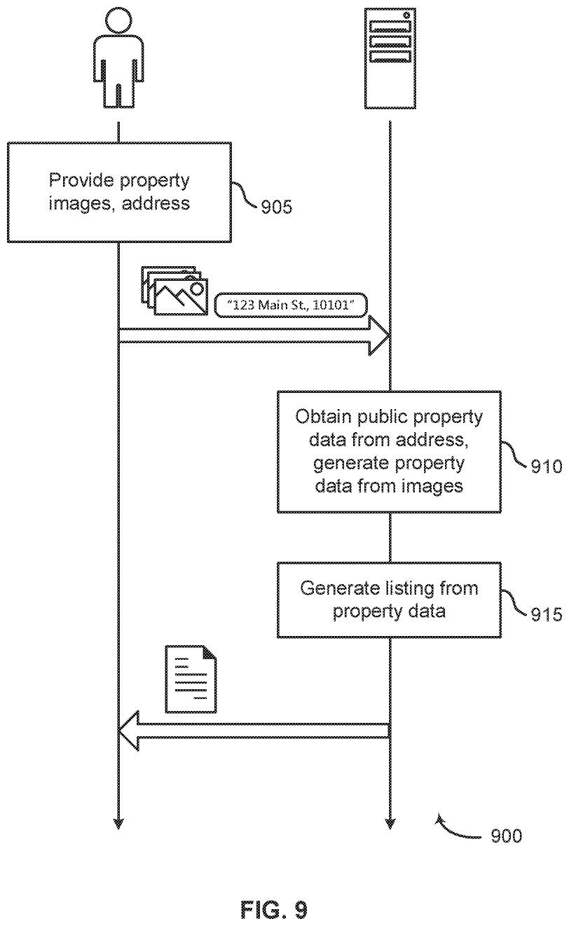

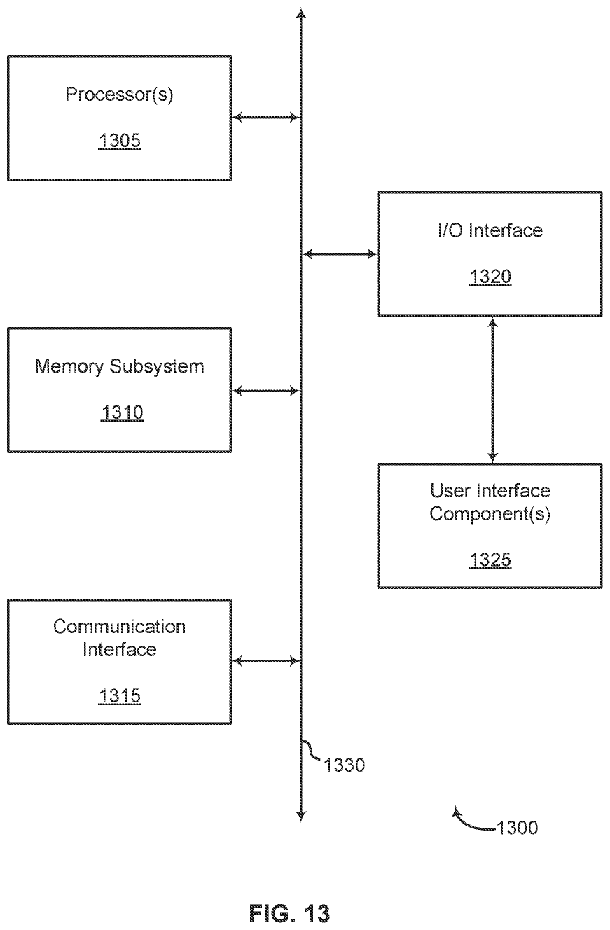

A property listing system is described with reference to FIGS. 1-8. Methods for generating property listings and responding to queries of those listings according to a privilege hierarchy are described with reference to FIGS. 9-12. A computing device configured to implement a property listing apparatus is described with reference to FIG. 13.

As used herein, “features” refers to either aspects of the property or numerical representations of encoded information, such as feature vectors. It will be appreciated by a person of ordinary skill in the art what the “features” are referring to based on the context of the description surrounding the use of the word. In the case of numerical representations, the feature vector may adhere to an explicit coding scheme, wherein each number represents a value of a labeled attribute, or the feature vector may include values that are understandable by a machine learning model for a downstream task.

FIG. 1 shows an example of a property listing system according to aspects of the present disclosure. The example shown includes property listing apparatus 100, database 105, network 110, and user 115. In an example process, a user 115 who wishes to generate a property listing provides input media of a property including image(s) or video(s). The user 115 may further provide other information about the property, such as an address, and may be prompted to include some form of proof-of-ownership. The property listing apparatus 100 then processes the input media to generate property data, and processes the property data to generate a property description. The property listing apparatus 100 may also combine the generated information with available information based on the address to generate a property listing, and provide the property listing to the user 115 for editing or approval.

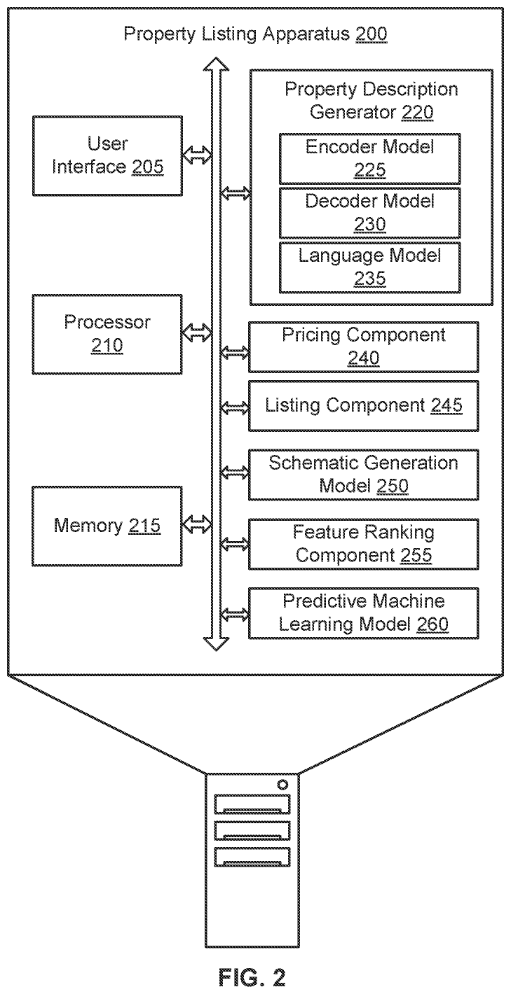

The property listing apparatus 100 or its components may be implemented on one or more servers. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus. Property listing apparatus 100 is an example of, or includes aspects of, the corresponding element described with reference to FIG. 2.

Database 105 stores information used by property listing apparatus 100 such as previously generated listings, listing templates, legal references, cached blockchain entries, user data, and the like. A database is an organized collection of data. For example, a database stores data in a specified format known as a schema. A database may be structured as a single database, a distributed database, multiple distributed databases, or an emergency backup database. In some cases, a database controller may manage data storage and processing in a database. In some cases, a user interacts with the database controller. In other cases, the database controller may operate automatically without user interaction.

Network 110 facilitates the transfer of information between property listing apparatus 100, database 105, and user 115. Network 100 may be referred to as a “cloud.” A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

FIG. 2 shows an example of a property listing apparatus 200 according to aspects of the present disclosure. The example shown includes property listing apparatus 200, user interface 205, processor 210, memory 215, property description generator 220, pricing component 240, listing component 245, schematic generation model 250, feature ranking component 255, and predictive machine learning model 260.

A user interface 205 may enable a user to interact with a device. In some embodiments, the user interface 205 includes an audio device, such as an external speaker system, an external display device such as a display screen, or an input device (e.g., remote control device interfaced with the user interface directly or through an IO controller module). In some cases, a user interface may be a graphical user interface 205 (GUI). For example, a user may upload images and video, as well specify other property information, via a GUI.

A processor 210 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor is configured to operate a memory array using a memory controller. In other cases, a memory controller is integrated into the processor 210. In some cases, the processor 210 is configured to execute computer-readable instructions stored in memory to perform various functions. In some embodiments, a processor includes special purpose components for modem processing, baseband processing, digital signal processing, or transmission processing.

Memory 215 stores information used during the operations of property listing apparatus 200. For example, memory 215 may cache information from the database described with reference to FIG. 1. Examples of a memory device include random access memory (RAM), read-only memory (ROM), or a hard disk. Examples of memory devices include solid state memory and a hard disk drive. In some examples, memory 215 is used to store computer-readable, computer-executable software including instructions that, when executed, cause processor 210 to perform various functions described herein. In some cases, the memory 215 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 215 store information in the form of a logical state.

Components of property listing apparatus 200 may be implemented using an artificial neural network (ANN) architecture. An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

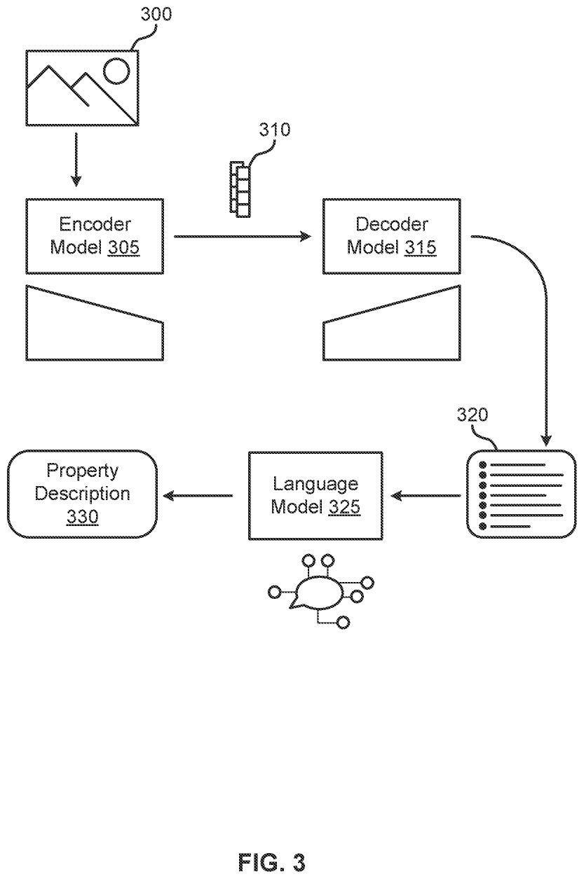

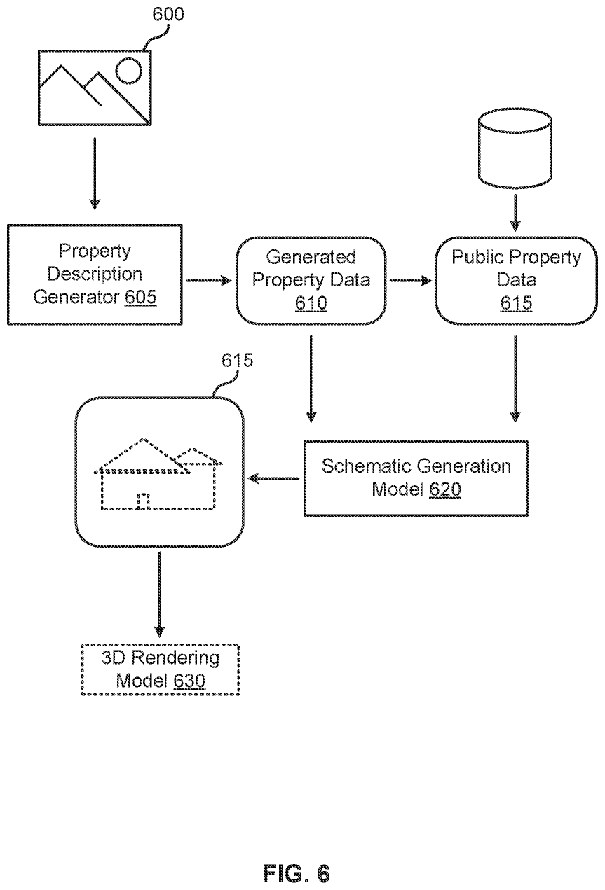

Property description generator 220 is configured to generate a textual description of a property from one or more input images. In one aspect, property description generator 220 includes encoder model 225, decoder model 230, and language model 235. Property description generator 220 is an example of, or includes aspects of, the corresponding element described with reference to FIG. 6. Encoder model 225 is an example of, or includes aspects of, the corresponding element described with reference to FIG. 3. Decoder model 230 is an example of, or includes aspects of, the corresponding element described with reference to FIG. 3. Language model 235 is an example of, or includes aspects of, the corresponding element described with reference to FIG. 3. Property listing apparatus 200 is an example of, or includes aspects of, the corresponding element described with reference to FIG. 1.

Encoder model 225 is configured to generate an image embedding based on an input image. An image embedding is an information-rich vector of numbers that encodes information about an image that is understandable by a decoder to translate into other information, such as a text description or property data. Embodiments of image encoder model 225 include a convolutional neural network (CNN).

A CNN a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

Decoder model 230 is configured to process the image embedding to generate property data. Property data may be a sequence of tokens or a text that includes information about a property. For example, the property data may include square footage, number(s) of rooms, color information, environment information (e.g., lakeside, mountain property, etc.), and the like). Embodiments of decoder model 230 are based on a transformer network.

A transformer or transformer network is a type of neural network models used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a.

In some cases, encoder model 225 may include or be based on the CLIP image encoder, which is a vision transformer. A vision transformer (e.g., a ViT model) is a neural network model configured for computer vision tasks. Unlike CNNs, ViTs use a transformer architecture, which was originally developed for natural language processing (NLP) tasks. ViTs break down an input image into a sequence of patches, which are then fed through a series of transformer encoder layers. The output of the final encoder layer is fed into a multi-layer perceptron (MLP) head for classification. ViTs can capture long-range dependencies between patches without relying on spatial relationships.

Language model 235 is configured to process the property data generated by decoder model 230 to generate property description. The property description may be a natural language description of the property details included in the property data. Embodiments of language model 235 are based on a transformer architecture, such as GPT-2, BERT, ROBERTa, T5, GPT-3, or the like. In some embodiments, the language model 235 is trained to generate property descriptions that are captivating to potential buyers by training on data that includes training property data and training property descriptions.

According to some aspects, property description generator 220 performs, using an encoder of an image processing network, a convolution process on the image to obtain an image embedding representing features of the image. In some examples, property description generator 220 decodes, using a decoder of the image processing network, the image embedding to obtain property data for the real property. In some examples, property description generator 220 generates, using a language generation model, a description of the real property based on the image and the property data. In some examples, property description generator 220 detects a change in the property data. In some examples, property description generator 220 regenerates the description based on the detected change. In some examples, property description generator 220 generates a caption for the image, where the description includes the caption.

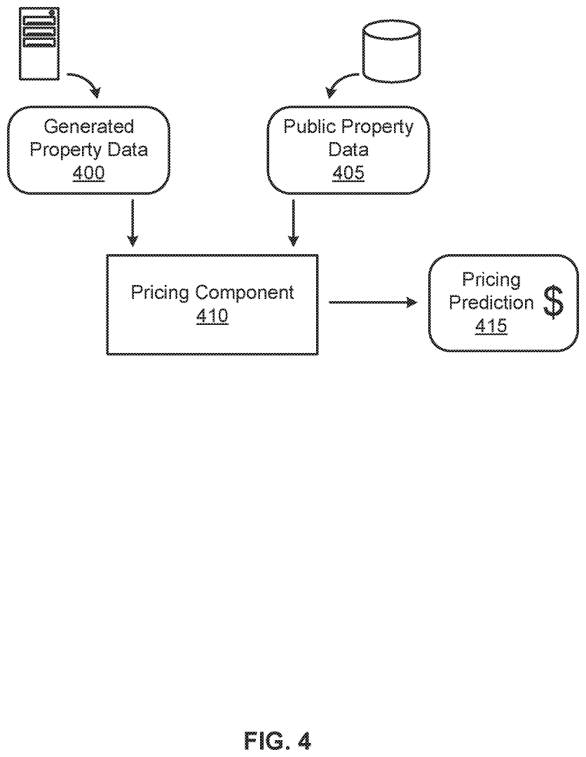

Pricing component 240 is configured to predict a market price for a real property based on property data. As used herein, “property data” may refer to the property data generated as an intermediate output from property description generator 220, property data that is available from an external source, or some combination thereof. Property data includes aspects about a property, such as square footage, number(s) of rooms, room details, appliances, accessibility, heating and cooling systems, building material, utility features, neighborhood features, county and tax details, and the like. Some embodiments of the property listing apparatus 200 include a listening mechanism that periodically pings an external data source to listen for changes and notify various components of property listing apparatus 200 to generate/upload a new listing in response to the changes. Embodiments of pricing component 240 include ML models such as regression-based models that are configured to extrapolate a price value from one or more input variables. The inputs may include, for example, geometric location, square footage, lot size, the inclusion of one or more property features (e.g., pool, guest house, etc.), and others. For example, a feature vector describing the property may be generated by pricing component 240 based on the property data, and used as input to a regression based model to predict the price for a property. Pricing component 240 is an example of, or includes aspects of, the corresponding element described with reference to FIG. 4.

Listing component 245 is configured to generate a property listing by combining the outputs of the other components of property listing apparatus 200 into a property listing template. Listing component 245 may further combine these outputs with externally available data about the property. Listing component 245 may map the information from the outputs and data into a listing template. In some cases, if there are any discrepancies between the property information and the listing template, the listing component 245 prompts the user to address the discrepancies via a user interface.

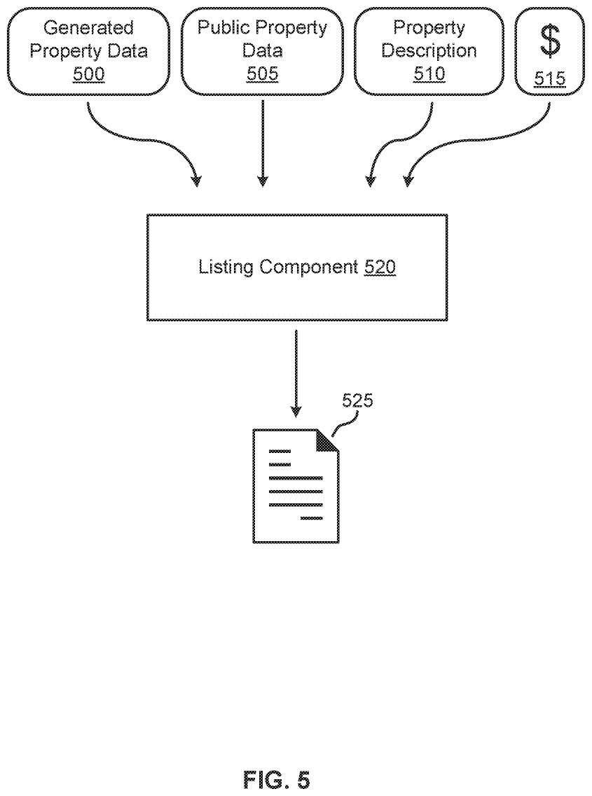

According to some aspects, listing component 245 identifies a listing format for the real property. In some examples, listing component 245 generates a listing for the real property based on the listing format, the property data, and the description of the real property. In some examples, listing component 245 identifies a compliance rule for the listing, where the listing is generated based on a compliance rule. Listing component 245 is an example of, or includes aspects of, the corresponding element described with reference to FIG. 5.

Schematic generation model 250 is configured to generate a property layout (sometimes referred to herein as a “design layout”) from property data. Some embodiments of schematic generation model 250 include a text-to-image model such as a diffusion model. The schematic generation model 250 may be fine-tuned to generate property schematics in a particular format, such as a top-down schematic format of a property. Schematic generation model 250 is an example of, or includes aspects of, the corresponding element described with reference to FIG. 6.

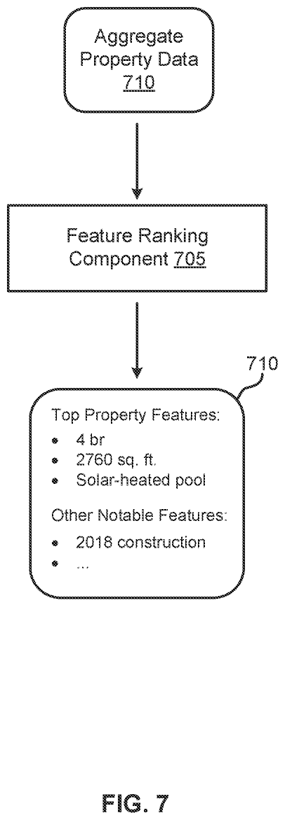

Feature ranking component 255 is configured to re-arrange property features from within a set of property data to be ordered by rank of importance. Embodiments can then augment property listing by placing the most important or marketable features of a property higher up in the description. Embodiments of feature ranking component 255 include ML-based models such as regression models, decision trees, or ANNs that are configured to re-order input property data by importance. In some cases, the ML-based models include configurable hyper-parameters that allow a user to weight particular features higher or lower. Feature ranking component 255 is an example of, or includes aspects of, the corresponding element described with reference to FIG. 7.

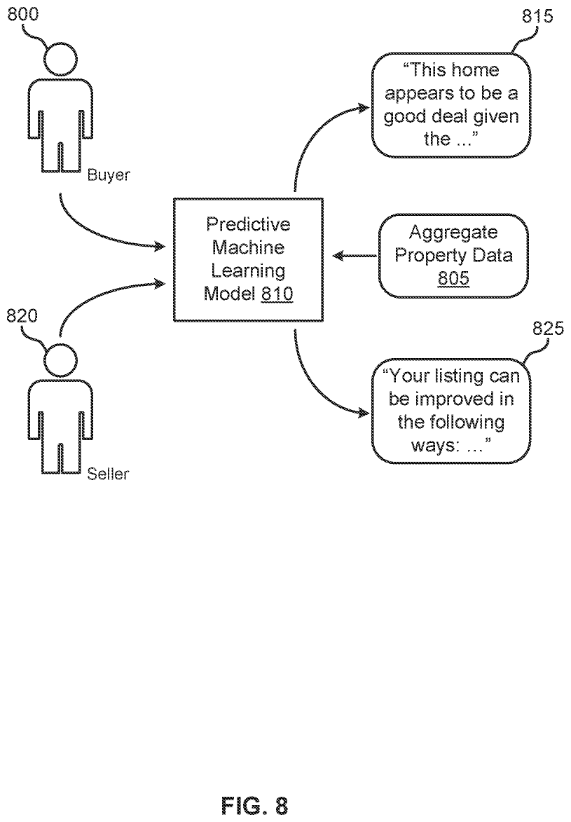

Predictive machine learning model 260 is configured to generate a property prediction to a buyer user or a seller user based on the property data. Embodiments of predictive machine learning model 260 include a language model such as GPT-2, BERT, or T5. For example, a buyer user may prompt the predictive machine learning model 260 to offer its recommendation to buy a selected property. A seller user may prompt the predictive machine learning model 260 for suggestions for augmenting a current listing. Predictive machine learning model 260 is an example of, or includes aspects of, the corresponding element described with reference to FIG. 8.

FIG. 3 shows an example of a property description generation pipeline according to aspects of the present disclosure. The example shown includes input image 300, encoder model 305, image features 310, decoder model 315, generated property data 320, language model 325, and property description 330. Encoder model 305, decoder model 315, and language model 325 are examples of, or include aspects of, the corresponding elements described with reference to FIG. 2. Generated property data 320 is an example of, or includes aspects of, the corresponding element described with reference to FIGS. 4-6.

In this example, an encoder model 305 processes input image 300 to generate image features 310. In some cases, the image features 310 are in a latent image embedding space, such as the CLIP embedding space. Embodiments of encoder model 305 include a CNN or a ViT. Then, decoder model 315 processes the image features 310 to generate generated property data 320. The property data may be textual descriptions of aspects about a property, or may be a feature vector in another embedding space similar to the image embedding space. Then, language model 325 receives the generated property data 320 as input and generates a property description 330 therefrom. The property description may be a natural language description about the property that includes information from generated property data 320. Accordingly, the property description generation pipeline transforms an input visual modality such as image(s) or video(s) to a language modality, e.g., the property description. According to some aspects, the property description generation pipeline is used to caption or “tag” input images and videos of a property.

FIG. 4 shows an example of a price prediction pipeline according to aspects of the present disclosure. The example shown includes generated property data 400, public property data 405, pricing component 410, and pricing prediction 415. Pricing component 410 is an example of, or includes aspects of, the corresponding element described with reference to FIG. 2.

In this example, pricing component 410 receives aggregate property data and generates pricing prediction 415 therefrom. The aggregate property data includes generated property data 400 from a property description generator as described with reference to FIGS. 2-3, as well as public property data 405. For example, the public property data 405 may be external data provided from a tax data source, such as local government records. The pricing component 410 uses ML-techniques to generate pricing prediction 415 from the property data. For example, a property data vector may be constructed including values for locations, room numbers, lot size, the presence of certain features, etc. and used as input to an ANN, where the output of the ANN is a price prediction value. According to some aspects, the predicted price may be treated as a premium feature of the property, and may be provided only on a privileged access layer of a distributed computer network.

FIG. 5 shows an example of a listing generation pipeline according to aspects of the present disclosure. The example shown includes public property data 500, generated property data 505, property description 510, pricing prediction 515, listing component 520, and generated property listing 525. Listing component 520 is an example of, or includes aspects of, the corresponding element described with reference to FIG. 2.

In this example, a listing component 520 receives multiple forms of input data, including public property data 500, generated property data 505, property description 510, and pricing prediction 515. The listing component 520 then matches each piece of input information to a listing template that is compliant with local regulations to generate generated property listing 525. For example, the listing component 520 may populate an MLS listing template. In this way, embodiments are configured to automatically fill out fields of a listing by using information extracted or generated by machine learning models such as the property description generator, which outputs both property description 510 and generated property data 505.

In at least one embodiment, listing component 520 further includes a listing auto-suggestion component which is configured to process a preliminary property listing to identify fields that may need review or confirmation by the listing user. For example, the listing auto-suggestion component may include a language model that is trained to identify values in the preliminary property listing that deviate from common values. This component may provide suggestions based on contextual information such as the other data in the preliminary property listing.

FIG. 6 shows an example of a schematic generation pipeline according to aspects of the present disclosure. The example shown includes input image 600, property description generator 605, generated property data 610, public property data 615, schematic generation model 620, generated property layout 625, and 3D rendering model 630.

Property description generator 605 is an example of, or includes aspects of, the corresponding element described with reference to FIG. 2. Generated property data 610 is an example of, or includes aspects of, the corresponding element described with reference to FIGS. 3-5. Public property data 615 is an example of, or includes aspects of, the corresponding element described with reference to FIGS. 4 and 5. Schematic generation model 620 is an example of, or includes aspects of, the corresponding element described with reference to FIG. 2.

According to some aspects, schematic generation model 620 is configured to generate a schematic, also referred to as a design layout, for a property based on information about its physical features such as size, dimensions, shape, and location. According to some aspects, these physical features are provided from generated property data 610 as generated by property description generator 605 based on input image 600, as well as external data such as public property data 615. Embodiments of the schematic generation model 620 include a text-to-image generator such as a diffusion model, though embodiments are not necessarily limited thereto and other generative models such as Generative Adversarial Networks (GANs), variational auto-encoders (VAEs), and the like may be used. In some cases, the property data is formatted as an input sequence of tokens. In some cases, the property's features are extracted and formed into an input vector. The schematic generation model 620 then generates generated property layout 625 using the input to condition the generative process. In at least one embodiment, the schematic generation model 620 uses image features from an encoder model of the property description generator 605 directly as input.

According to some aspects, the schematic generation model generates a generated property layout 625 that includes design element details such as the placement of windows, doors, and other architectural features, the use of color schemes, and the arrangement of furniture and décor. In at least one embodiment, the generated property layout 625 is input to a 3D rendering model 630 that is configured to generate a 3D model of the property as a rendering or as shape data. Embodiments of the 3D rendering model 630 include an image-to-shape translation model such as NeRF.

FIG. 7 shows an example of a feature ranking pipeline according to aspects of the present disclosure. The example shown includes aggregate property data 700, feature ranking component 705, and property features ordered by importance 710. Aggregate property data 700 is an example of, or includes aspects of, the corresponding element described with reference to FIG. 8. Feature ranking component 705 is an example of, or includes aspects of, the corresponding element described with reference to FIG. 2.

In this example, feature ranking component 705 processes aggregate property data 700, which may include both internally generated property data and externally sourced property data, to generate property features ordered by importance 710. Embodiments of feature ranking component 705 include a regression model configured to assign importance scores to each property feature of a set of property features. Examples of property features include the number of bedrooms, bathrooms, the size of the land, the location, the type of construction, and the presence of amenities such as swimming pools, gardens, and parking lots, features of the land, structure, amenities, and prices.

According to some aspects, the importance scores are assigned based on the context of the other property features and the predicted price of the property. In some cases, the feature ranking component 705 presents the top-K number of features (e.g., the top 3 features) in a first property description, and presents features that are of lower importance in a second property description. The property features ordered by importance 710 may be incorporated into a property listing using a listing component as described with reference to FIG. 2.

FIG. 8 shows an example of a user recommendation pipeline according to aspects of the present disclosure. The example shown includes buyer user 800, aggregate property data 805, predictive machine learning model 810, first prediction 815, seller user 820, and second prediction 825. Aggregate property data 805 is an example of, or includes aspects of, the corresponding element described with reference to FIG. 7. Predictive machine learning model 810 is an example of, or includes aspects of, the corresponding element described with reference to FIG. 2.

In this example, a buyer user 800 queries predictive machine learning model 810 to provide a recommendation for a selected property. The predictive machine learning model 810 may first obtain aggregate property data 805 about the property. Then, the predictive machine learning model 810 may use the property data as input, and append a value that indicates whether the querying user is a buyer or seller. The predictive machine learning model 810 may generate a first prediction 815 based on the input. The first prediction 815 may be a recommendation on whether to buy the property.

The seller user 820 may query the predictive machine learning model 810 about a property listing. For example, the seller user 820 may be in the process of automatically generating a property listing using the property listing apparatus as described with reference to FIG. 2. The predictive machine learning model 810 may use the currently generated and provided property data as well as an appended value indicating that the querying user is a seller as input to generate second prediction 825. The second recommendation 825 may be an initial opinion as to the quality of the listing, or may be a specific recommendation for improving the listing.

FIG. 9 shows an example of a method 900 for providing a listing to a user according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 905, the user provides property images and the address of the property. According to some aspects, the property images may include images of both external and internal views of the property, and may further include video content. The address of the property may include street, city, state, ZIP, country, or GPS coordinate information, or a combination thereof.

At operation 910, the system obtains public property data from the address and generates property data from images. For example, the system may fetch local tax data about the property based on the address, as well as generate property data according to the process described with reference to FIG. 3.

At operation 915, the system generates a listing from the property data. The operations of this step may be performed by a listing component as described with reference to FIGS. 2 and 5. The listing may include a description of the property, a predicted price, various features about the property, captioned image(s) and video(s) of the property, and other information that satisfies regulatory requirements of the location of the property.

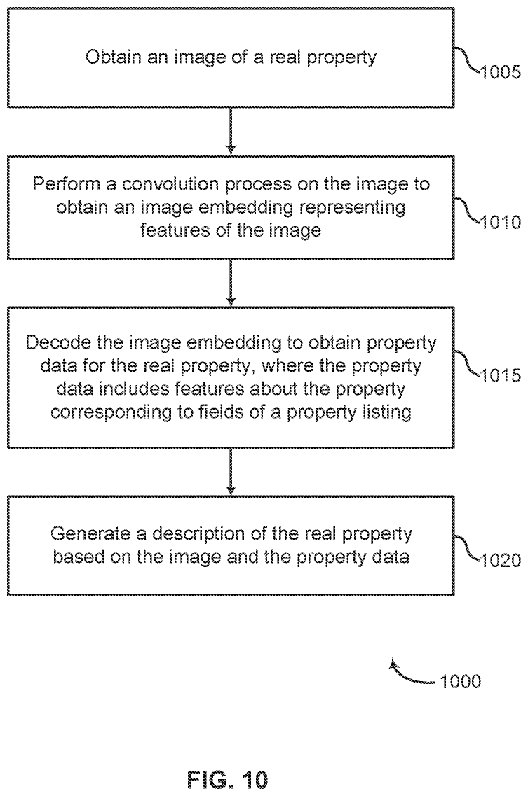

FIG. 10 shows an example of a method 1000 for generating a property description according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, the system obtains an image of a real property. In some cases, the operations of this step refer to, or may be performed by, a property listing apparatus as described with reference to FIGS. 1 and 2. The image may be an indoors or outdoors view of the property.

At operation 1010, the system performs a convolution process on the image to obtain an image embedding representing features of the image. In some cases, the operations of this step refer to, or may be performed by, an encoder of a property description generator as described with reference to FIGS. 2 and 3. For example, the encoder may process the image using a convolution process to obtain image features encoded into the image embedding. Embodiments of the encoder include a CNN, a ViT, or a combination thereof (e.g., a ViT configured to perform an attention process on an output of the CNN).

At operation 1015, the system decodes the image embedding to obtain property data for the real property, where the property data includes features about the property corresponding to fields of a property listing. In some cases, the operations of this step refer to, or may be performed by, a decoder of the property description generator as described with reference to FIGS. 2 and 6. The decoder may be trained to translate the image embedding into property data that includes information about the property. The property data may include words or a list of clauses that describe aspects of the property, or may include a vector representation of the property with encoded values corresponding to location, the number of rooms, the dimensions of the property, the lot size, the presence of property features, etc.

At operation 1020, the system generates a description of the real property based on the image and the property data. In some cases, the operations of this step refer to, or may be performed by, a language model of the property description generator as described with reference to FIGS. 2 and 3. Accordingly, the system is configured to translate a first input modality such as a vision modality into a second modality different from the first modality, such as a language modality. In this way, embodiments automate the process of captioning input media about a property, as well as extract material information about the property from the input media.

According to some aspects, embodiments are further configured to incorporate the property description and the property data into a property listing, as described with reference to FIG. 5. For example, a listing component may map the property features in the property data to fields of a listing. Property features can include, but are not limited to, square footage, the number of rooms, the year the property was built, zoning ordinances, construction style, appliance information, pools, yards, furnishing, basement condition, neighborhood features, and the like.

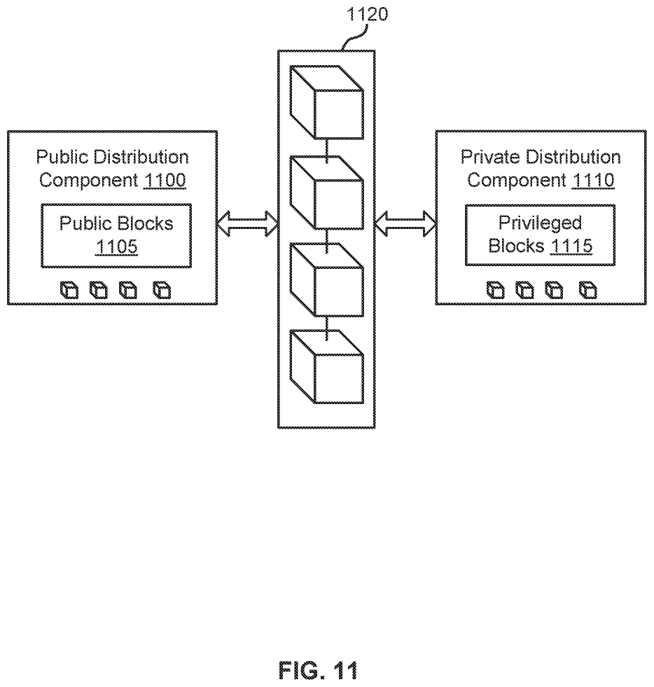

FIG. 11 shows an example of public and private layers according to aspects of the present disclosure. The example shown includes public distribution component 1100, private distribution component 1110, and blockchain 1120.

Public distribution component 1100 interacts with blockchain 1120. Public distribution component 1100 may submit transactions to be added to blockchain 1120, and may prevent unauthorized transactions from being submitted to blockchain 1120. An example of blockchain 1120 is Flow blockchain, though the methods described herein are not limited to operations thereon. In one aspect, public distribution component 1100 includes public blocks 1105. For example, public distribution component 1100 may submit transactions with public data according to instruction from a smart contract. Public blocks 1105 may include general information about a property or a user. For example, in the case of a property listing, public blocks 1105 may include the property address, square footage, images, and features.

Private distribution component 1110 also interacts with blockchain 1120. In one aspect, private distribution component 1110 includes privileged blocks 1115. For example, private distribution component 1110 may submit transactions with sensitive or privileged data according to instruction from a smart contract. Privileged blocks 1115 may include privileged information about a property or a user. For example, in the case of a property listing, privileged blocks 1115 may include unsettled offers for the property, identifying information about the buyers and the sellers, results from inspections, appraisals, and the like.

According to some aspects, public distribution component 1100 distributes the listing via a public listing distribution. According to some aspects, public distribution component 1100 provides the public information via a public access layer of a distributed computer network in response to a public request for information about the real property. In some aspects, the distributed computer network includes a blockchain-based distributed ledger.

According to some aspects, private distribution component 1110 generates a private listing including the property prediction. In some examples, private distribution component 1110 distributes the private listing via a restricted listing distribution. In some examples, private distribution component 1110 stores the private listing on a blockchain 1120-based public ledger. In some examples, private distribution component 1110 receives a signed transaction indicating that a user is authorized to view the private listing. In some examples, private distribution component 1110 provides the private listing to the user via the blockchain-based public ledger based on the signed transaction.

According to some aspects, private distribution component 1110 provides the private information via a privileged access layer of the distributed computer network in response to a verified request for information about the real estate property. In some examples, private distribution component 1110 receives a first verification from a first user via the privileged access layer of the distributed computer network. In some examples, private distribution component 1110 receives a second verification from a second user via the privileged access layer of the distributed computer network, where the private information is provided based on the first verification and the second verification.

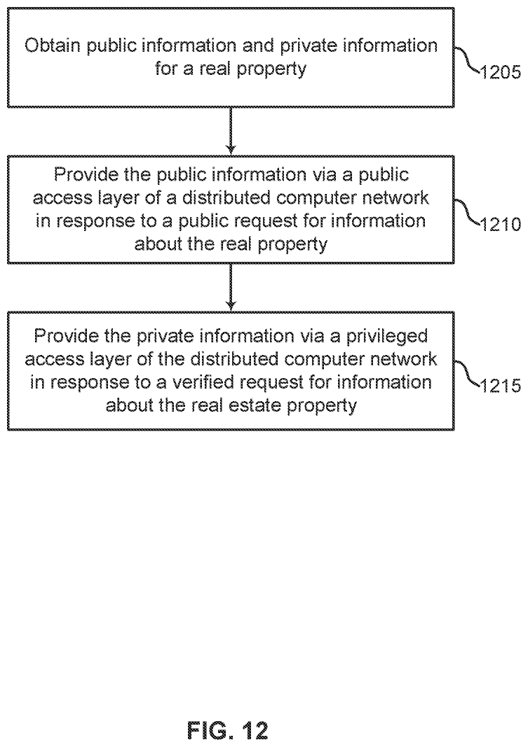

FIG. 12 shows an example of a method 1200 for distributing property listings according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1205, the system obtains public information and private information for a real property. In some cases, the operations of this step refer to, or may be performed by, a property listing apparatus as described with reference to FIGS. 1 and 2. Public information may include information that is intended for any member of the public, such as a property description, address information, square footage, and other information that is not privileged.

At operation 1210, the system provides the public information via a public access layer of a distributed computer network in response to a public request for information about the real property. In some cases, the operations of this step refer to, or may be performed by, a public distribution component as described with reference to FIG. 11. The distributed computer network may be a blockchain-based network, though embodiments are not necessarily limited thereto.

At operation 1215, the system provides the private information via a privileged access layer of the distributed computer network in response to a verified request for information about the real estate property. In some cases, the operations of this step refer to, or may be performed by, a private distribution component as described with reference to FIG. 11. The verified request may include, for example, user credentials that are verified with information on a database or a smart contract. Private information may include, for example, premium features about the property that are generated by the system. Premium features may include predicted data such as market pricing, pricing trajectories, buying/selling recommendations, and the like.

FIG. 13 shows an example of a computing device 1300 according to aspects of the present disclosure. The example shown includes computing device 1300, processor(s), memory subsystem 1310, communication interface 1315, I/O interface 1320, user interface component(s), and channel 1330.

In some embodiments, computing device 1300 is an example of, or includes aspects of, a property listing apparatus illustrated in FIGS. 1-2. In some embodiments, computing device 1300 includes one or more processors 1305 that can execute instructions stored in memory subsystem 1310 to obtain an image of a real property; perform, using an encoder of an image processing network, a convolution process on the image to obtain an image embedding representing features of the image; decode, using a decoder of the image processing network, the image embedding to obtain property data for the real property; and generate, using a language generation model, a description of the real property based on the image and the property data.

According to some aspects, computing device 1300 includes one or more processors 1305. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1310 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1315 operates at a boundary between communicating entities (such as computing device 1300, one or more user devices, a cloud, and one or more databases) and channel 1330 and can record and process communications. In some cases, communication interface 1315 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1320 is controlled by an I/O controller to manage input and output signals for computing device 1300. In some cases, I/O interface 1320 manages peripherals not integrated into computing device 1300. In some cases, I/O interface 1320 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1320 or via hardware components controlled by the I/O controller.

According to some aspects, user interface component(s) 1325 enable a user to interact with computing device 1300. In some cases, user interface component(s) 1325 include an audio device, such as an external speaker system, an external display device such as a display screen, an input device (e.g., a remote control device interfaced with a user interface directly or through the I/O controller), or a combination thereof. In some cases, user interface component(s) 1325 include a GUI.

Accordingly, the present disclosure includes the following aspects.

A method for generating real property listings is described. One or more aspects of the method include obtaining an image of a real property; performing, using an encoder of an image processing network, a convolution process on the image to obtain an image embedding representing features of the image; decoding, using a decoder of the image processing network, the image embedding to obtain property data for the real property; and generating, using a language generation model, a description of the real property based on the image and the property data.

Some examples of the method, apparatus, non-transitory computer readable medium, and system further include identifying a listing format for the real property. Some examples further include generating a listing for the real property based on the listing format, the property data, and the description of the real property. Some examples of the method, apparatus, non-transitory computer readable medium, and system further include distributing the listing via a public listing distribution. Some examples further include identifying a compliance rule for the listing, wherein the listing is generated based at least in part on the compliance rule. Some examples further include generating, using a predictive machine learning model, a property prediction based on the image.

Some examples of the method, apparatus, non-transitory computer readable medium, and system further include generating a private listing including the property prediction. Some examples further include distributing the private listing via a restricted listing distribution. Some examples further include storing the private listing on a blockchain-based public ledger. Some examples further include receiving a signed transaction indicating that a user is authorized to view the private listing. Some examples further include providing the private listing to the user via the blockchain-based public ledger based on the signed transaction. Some examples of the method, apparatus, non-transitory computer readable medium, and system further include detecting a change in the property data. Some examples further include regenerating the description based on the detected change. Some examples further include generating a caption for the image, wherein the description includes the caption.

A method for generating real property listings is described. One or more aspects of the method include obtaining public information and private information for a real property; providing the public information via a public access layer of a distributed computer network in response to a public request for information about the real property; and providing the private information via a privileged access layer of the distributed computer network in response to a verified request for information about the real estate property.

Some examples of the method, apparatus, non-transitory computer readable medium, and system further include receiving a first verification from a first user via the privileged access layer of the distributed computer network. Some examples further include receiving a second verification from a second user via the privileged access layer of the distributed computer network, wherein the private information is provided based on the first verification and the second verification. In some aspects, the distributed computer network comprises a blockchain-based distributed ledger. Some examples of the method, apparatus, non-transitory computer readable medium, and system further include generating, using a predictive machine learning model, a property prediction for the real property, wherein the private information includes the property prediction.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an image of a real property;
performing, using an encoder of an image processing network, a convolution process on the image to obtain an image embedding representing features of the image;
decoding, using a decoder of the image processing network, the image embedding to obtain property data for the real property; and
generating, using a language generation model, a description of the real property based on the image and the property data.

2. The method of claim 1, further comprising:
identifying a listing format for the real property; and
generating a listing for the real property based on the listing format, the property data, and the description of the real property.

3. The method of claim 2, further comprising:
distributing the listing via a public listing distribution.

4. The method of claim 2, further comprising:
identifying a compliance rule for the listing, wherein the listing is generated based at least in part on the compliance rule.

5. The method of claim 1, further comprising:
generating, using a predictive machine learning model, a property prediction based on the image.

6. The method of claim 5, further comprising:
generating a private listing including the property prediction.

7. The method of claim 6, wherein distributing the private listing comprises:
distributing the private listing via a restricted listing distribution.

8. The method of claim 7, further comprising:
storing the private listing on a blockchain-based public ledger;
receiving a signed transaction indicating that a user is authorized to view the private listing; and
providing the private listing to the user via the blockchain-based public ledger based on the signed transaction.

9. The method of claim 1, further comprising:
detecting a change in the property data; and
regenerating the description based on the detected change.

10. The method of claim 1, further comprising:
generating a caption for the image, wherein the description includes the caption.

11. A method comprising:
obtaining public information and private information for a real property;
providing the public information via a public access layer of a distributed computer network in response to a public request for information about the real property; and
providing the private information via a privileged access layer of the distributed computer network in response to a verified request for information about the real estate property.

12. The method of claim 11, further comprising:
receiving a first verification from a first user via the privileged access layer of the distributed computer network; and
receiving a second verification from a second user via the privileged access layer of the distributed computer network, wherein the private information is provided based on the first verification and the second verification.

13. The method of claim 11, wherein:
the distributed computer network comprises a blockchain-based distributed ledger.

14. The method of claim 11, further comprising:
generating, using a predictive machine learning model, a property prediction for the real property, wherein the private information includes the property prediction.
